(19) United States
(12) Patent Application Publication
(10) Pub. No.: US 2021/0299702 A1
(43) Pub. Date: Sep. 30, 2021

(54) METALLIC FILM MANUFACTURING METHOD AND METALLIC FILM

(71) Applicants: TOYOTA JIDOSHA KABUSHIKI KAISHA, Toyota-shi (JP); KONAN GAKUEN, Kobe-shi (JP)

(72) Inventors: Daiki Kuboyama, Toyota-shi (JP); Akira Kato, Toyota-shi (JP); Junya Murai, Nissin-shi (JP); Kensuke Akamatsu, Kobe-shi (JP)

(73) Assignees: TOYOTA JIDOSHA KABUSHIKI KAISHA, Toyota-shi (JP); KONAN GAKUEN, Kobe-shi (JP)

(21) Appl. No.: 17/204,256

(22) Filed: Mar. 17, 2021

(30) Foreign Application Priority Data
Mar. 27, 2020 (JP) 2020-057203
Nov. 5, 2020 (JP) 2020-185373

(51) Int. Cl. B05D 7/02; B05D 3/10

(52) U.S. Cl. CPC B05D 7/02; B05D 2505/50; B05D 3/101

(57) ABSTRACT

A present disclosure relates to a metallic film manufacturing method including a first step of forming a layer which has functional groups ion-exchangeable with metal ions on a surface of a resin substrate made of an insulating material, a second step of treating the resin substrate having the layer with a metal ion solution such that metal ions are introduced into the layer by ion exchange, and a third step of treating the resin substrate with a reducing agent such that metal particles are precipitated on a surface of the layer. The present disclosure relates to a metallic film manufacturing method a metallic film in which there are voids between metal particles precipitated on a surface of the metallic film, and the average particle diameter of the metal particles is 5 nm to 200 nm.

### CROSS-REFERENCE TO RELATED APPLICATION

This application claims priority to Japanese Patent Application No. 2020-057203 filed on Mar. 27, 2020 and Japanese Patent Application No. 2020-185373 filed on Nov. 5, 2020, each incorporated herein by reference in its entirety.

### BACKGROUND

### 1. Technical Field

The present disclosure relates to a metallic film manufacturing method and a metallic film.

### 2. Description of Related Art

Metallic films can give metallic luster with high brightness to the surface of products and make the products look classy. Therefore, these films are used in various products. The metallic films need to have various characteristics depending on the products to be used. For example, radio wave transmission properties are one of such characteristics. For instance, a millimeter-wave radar mounted on an automobile or the like is a device which emits millimeter waves (radio waves having a wavelength of 1 to 10 mm) as radio waves and measures the distance to obstacles by calculating the time taken for the reflected radio waves to return. In a case where a metallic film is used for this millimeter-wave radar, the metallic film needs to have excellent metallic luster and millimeter wave transmission properties.

As a metallic film having radio wave transmission properties, for example, a metallic film is known which is obtained by forming an indium (In) or tin (Sn) film on a surface of a substrate by vapor deposition or sputtering. (Japanese Unexamined Patent Application Publication No. 2016-65297 (JP 2016-65297 A), Japanese Unexamined Patent Application Publication No. 2007-285093 (JP 2007-285093 A), Japanese Unexamined Patent Application Publication No. 2013-144902 (JP 2013-144902 A), Japanese Unexamined Patent Application Publication No. 2019-188809 (JP 2019-188809 A)). However, because indium and tin have low reflectance, the brightness is limited. Furthermore, the sputtering process is costly because it is a vacuum batch process. In addition, in the case of vapor deposition, metal particles, such as indium and tin, may be peeled off because they are simply placed on a film surface. Therefore, an adhesive layer is needed for enhancing the adhesion between the substrate surface and the metal particles.

### SUMMARY

As described above, in the conventional metallic film manufacturing method, such as vapor deposition or sputtering, the adhesion between a substrate and metal particles is weak, which sometimes leads to the decrease in stability of the metal particles and the increase in costs. The present disclosure provides a low-cost method for manufacturing a metallic film which has high brightness and radio wave transmission properties and retains metal particles with high stability.

As a result of various studies, the inventors of the present disclosure have found that by forming a layer which has functional groups ion-exchangeable with metal ions on a surface of a resin substrate and performing ion exchange and a reduction treatment, it is possible to manufacture a highly stable metallic film at low cost while achieving both the high brightness and radio wave transmission properties at low cost.

A first aspect of the present disclosure relates to a metallic film manufacturing method including a first step of forming a layer which has functional groups ion-exchangeable with metal ions on a surface of a resin substrate made of an insulating material, a second step of treating the resin substrate having the layer which has functional the groups ion-exchangeable with the metal ions and is formed on the surface of the resin substrate with a metal ion solution such that metal ions are introduced into the layer by ion exchange, and a third step of treating the resin substrate having the layer into which the metal ions are introduced on the surface of the resin substrate with a reducing agent such that metal particles are precipitated on a surface of the layer of the layer. There are voids between the metal particles precipitated on the surface, and an average particle diameter of the metal particles is 5 nm to 200 nm.

(2) The metal ions may be ions of one or more metals selected from Ag, Al, Au, Ti, Cr, Mn, Fe, Ni, Cu, Zn, Zr, Nb, Mo, In, Co, and Sn.

(3) The metallic film manufacturing method may further include a fourth step of performing a heat treatment after the third step.

(4) In the first step, the surface of the resin substrate may be modified such that the layer having the functional groups ion-exchangeable with the metal ions is formed on the surface of the resin substrate.

(5) The resin substrate may be a resin having a group that is convertible into at least one of a carboxyl group or a sulfo group.

(6) The resin substrate may be polyimide.

(7) In the first step, a film layer having the functional groups ion-exchangeable with the metal ions may be formed on the surface of the resin substrate.

(8) The resin substrate having the layer into which the metal ions are introduced on the surface of the resin substrate may be treated with a reducing agent solution in which a concertation of the reducing agent is 0.01 mM to 1 mM such that the metal particles are precipitated on the surface of the layer

(9) A second aspect of the present disclosure relates to a metallic film having a resin substrate and a metal particle layer formed on the resin substrate. In the metal particle layer, there are voids between metal particles, and an average particle diameter of the metal particles is 5 nm to 200 nm. In a section of the metallic film, in a case where c represents a horizontal major diameter (nm) of each of the metal particles, a₁ represents a horizontal distance (nm) between a first endpoint of the horizontal major diameter of each of the metal particles and a first portion of each of the metal particles embedded in the resin substrate on the horizontal major diameter, and a₂ represents a horizontal distance (nm) between a second endpoint of the horizontal major diameter and a second portion of each of the metal particles embedded in the resin substrate on the horizontal major diameter, c, a₁, and a₂ satisfy 0<a₁/c, 0<a₂/c, and a₁+a₂≤c.

According to an aspect of the present disclosure, a metallic film which has high brightness and radio wave transmission properties and retains metal particles with high stability can be manufactured at low cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing the process of a first embodiment of the method of the present disclosure;

FIG. 2 is a schematic sectional view of a metallic film obtained by the first embodiment of the method of the present disclosure;

FIG. 3 is a view showing the process of a second embodiment of the method of the present disclosure;

FIG. 4 is a schematic sectional view of a metallic film obtained by the second embodiment of the method of the present disclosure;

FIG. 5 is a scanning electron microscope (SEM) image of a surface of a metallic film of Example 1;

FIG. 6 is a transmission electron microscope (TEM) image of a section of the metallic film of Example 1;

FIG. 7 is a graph showing the millimeter wave attenuation in Example 1 and in a substrate used alone;

FIG. 8 is a scanning electron microscope (SEM) image of a surface of a metallic film of Example 2;

FIG. 9A is a schematic sectional view of a metallic film of an aspect of the present disclosure;

FIG. 9B is a partially enlarged sectional view of the portion in the dotted line in FIG. 9A; and

FIG. 10 is a transmission electron microscope (TEM) image of a section of a metallic film of Example 3.

### DETAILED DESCRIPTION OF EMBODIMENTS

Hereinafter, preferred embodiments of the present disclosure will be specifically described.

The present disclosure relates to a metallic film manufacturing method. The metallic film manufacturing method according to an aspect of the present disclosure includes a first step of forming a layer which has functional groups ion-exchangeable with metal ions on a surface of a resin substrate made of an insulating material, a second step of treating the resin substrate having the layer, which has functional groups ion-exchangeable with metal ions, formed on the surface of the resin substrate with a metal ion solution such that metal ions are introduced into the layer by ion exchange, and a third step of treating the resin substrate having the layer into which the metal ions are introduced on the surface of the resin substrate with a reducing agent such that metal particles are precipitated on a surface of the layer.

In the first step, a layer having functional groups ion-exchangeable with metal ions is formed on a surface of a resin substrate made of an insulating material.

The resin substrate is made of an insulating material. As the resin substrate, resin films can be used without particular limitation. As the resin substrate, for example, a resin having a group convertible into at least one of a carboxyl group or a sulfo group can be used. The resin substrate is not particularly limited. For example, polycarbonate, acryl, polystyrene, polyimide, polyethylene terephthalate, polymethylmethacrylate, and ABS can be used.

The thickness of the resin substrate is usually 10 μm to 5 mm.

The metal ions are not particularly limited, and, for example, are ions of Ag, Al, Au, Ti, Cr, Mn, Fe, Ni, Cu, Zn, Zr, Nb, Mo, In, Co, and Sn. Among these, ions of Ag, Al, and Cr are preferable, and Ag ions are more preferable, because these ions have high brightness.

In the first step, the layer having functional groups ion-exchangeable with metal ions may be formed, for example, by modifying a surface of the resin substrate (first embodiment). Alternatively, the layer having functional groups ion-exchangeable with metal ions may be formed as a film on a surface of the resin substrate (second embodiment). That is, the layer having functional groups ion-exchangeable with metal ions may be a layer derived from the resin substrate or a new layer that is not derived from the resin substrate.

In the first step, the density of the functional groups in the layer having functional groups ion-exchangeable with metal ions is preferably 1 mol/1 to 10 mol/l, and more preferably 5 mol/1 to 8 mol/l.

In the first step, the thickness of the layer having functional groups ion-exchangeable with metal ions is preferably 0.5 μm to 10 μm, and more preferably 0.7 μm to 1.5 μm. The thickness of the layer can be measured by observing a section of the layer with a field emission scanning electron microscope (FE-SEM).

In the second step, the resin substrate having the layer, which has functional groups ion-exchangeable with metal ions, formed on the surface of the resin substrate in the first step is treated with a metal ion solution. By this treatment, the functional groups ion-exchangeable with metal ions are exchanged with metal ions by ion exchange, and the metal ions are introduced into the layer. Because the functional groups ion-exchangeable with metal ions are dispersed in the layer, the introduced metal ions are embedded in the layer. The functional groups ion-exchangeable with metal ions may not be totally substituted with the metal ions, and some of the functional groups may remain as functional groups.

In the second step, the metal ion solution may be a solution containing the metal ions. As the metal ion solution, metal ion salt solutions can be used without particular limitation. Examples of the salt include nitrate, sulfate, chloride, carbonate, acetate, and phosphate.

The concentration of the metal ion solution is usually 1 mM (mmol/l) to 500 mM, and preferably 50 mM to 150 mM.

The treatment with the metal ion solution can be performed, for example, by immersing the resin substrate in the metal ion solution. Regarding the condition of the treatment with the metal ion solution, the treatment temperature is usually 10° C. to 50° C. and preferably 20° C. to 30° C., and the treatment time is usually 10 seconds to 120 minutes and preferably 1 minute to 60 minutes.

In the second step, the density of the metal ions in the layer into which the metal ions are introduced is preferably 1 mol/1 to 10 mol/l, and more preferably 5 mol/1 to 8 mol/l.

In the third step, the resin substrate having the layer, into which the metal ions are introduced in the second step, on the surface of the resin substrate is treated with a reducing agent. By this treatment, the metal ions diffuse to the surface where the reducing agent is present and are reduced to metal particles, and some of the metal particles are precipitated on the surface in a state of being embedded in the surface.

The reducing agent is not particularly limited, and examples thereof include a phosphoric acid-based compound, a boron hydride compound, and a hydrazine derivative.

Examples of the phosphoric acid-based compound include hypophosphorous acid, phosphorous acid, pyrophosphoric acid, and polyphosphoric acid. Examples of the boron hydride compound include methyl hexaborane, dimethylamine borane, diethylamine borane, morpholine borane, pyridine amine borane, piperidine borane, ethylenediamine borane, ethylenediamine bisborane, t-butylamine borane, imidazole borane, methoxyethylamine borane, and sodium borohydride. As the hydrazine derivative, it is possible to use hydrazine salts, such as hydrazine sulfate and hydrazine hydrochloride, and hydrazine derivatives, such as pyrazoles, triazoles, and hydrazides. Among these, as the pyrazoles, in addition to pyrazole, pyrazole derivatives, such as 3,5-dimethylpyrazole and 3-methyl-5-pyrazolone, can be used. As the triazoles, 4-amino-1,2,4-triazole, 1,2,3-triazole, and the like can be used. As the hydrazides, adipic acid hydrazide, maleic acid hydrazide, carbohydrazide, and the like can be used. The reducing agent is preferably dimethylamine borane (DMAB).

The treatment with the reducing agent can be performed, for example, by immersing the resin substrate in a reducing agent solution. The concentration of the reducing agent solution is usually 0.01 mM to 500 mM and preferably 0.1 mM to 20 mM. Regarding the condition of the treatment with the reducing agent, the treatment temperature is usually 10° C. to 60° C. and preferably 25° C. to 50° C., and the treatment time is usually 10 seconds to 60 minutes and preferably 30 seconds to 30 minutes. In the present disclosure, by adjusting the treatment time and the treatment temperature depending on the reducing power of the reducing agent used, it is possible to make voids between the precipitated metal particles and to allow the metal particles to have a specific average particle diameter.

In a preferred embodiment, the concentration of the reducing agent solution is 0.01 mM to 1 mM and preferably 0.1 mM to 0.5 mM. In a case where the reducing agent solution has a low concentration ranging from 0.01 mM to 1 mM, the growth rate of the metal particles decreases, and the metal particles grow while pushing the resin substrate. Furthermore, because the reducing agent solution infiltrates into the resin substrate even before the metal ions are reduced, the metal ions can be reduced in the interior of the resin substrate. Accordingly, the metal particles are precipitated in a state of being more deeply embedded in the surface of the resin substrate. As a result, the adhesion of the metal particles is enhanced, and the durability and wear resistance of the metal particles are improved. Regarding the condition of the treatment with the reducing agent in this embodiment, the treatment temperature is preferably 10° C. to 60° C., more preferably 30° C. to 60° C., and particularly preferably 50° C., and the treatment time is preferably 10 seconds to 30 minutes and more preferably 30 seconds to 5 minutes. In a case where the above reducing condition is adopted, it is possible to improve the adhesion, durability, and wear resistance of the metal particles while reducing the amount of the reducing agent used.

The method according to an aspect of the present disclosure may further include a fourth step of performing a heat treatment after the third step. By this treatment, the layer into which the metal ions are introduced can be converted. In one embodiment, in a case where the layer contains at least one of a carboxyl group or a sulfo group, these groups are dehydrated by the heat treatment. In this embodiment, the heat treatment temperature is usually 100° C. to 300° C.

In the metallic film obtained by the method according to an aspect of the present disclosure, there are voids between the metal particles precipitated on the surface of the metallic film, and the average particle diameter of the metal particles is 5 nm to 200 nm. In the present disclosure, by adjusting the amount of metal ions introduced in the second step and the reducing condition in the third step, it is possible to cause the metal particles having a specific average particle diameter to be precipitated with voids.

In the metal particle layer on the outermost surface of the metallic film, the metal particles are preferably in the form of islands. That is, the metal particles in the metal particle layer are present as independent particles that are slightly separated from each other.

The shape of the metal particles is not particularly limited, and may be, for example, spherical, ellipsoidal, plate-like, flake-like, scale-like, dendritic, rod-like, wire-like, or amorphous.

The thickness of the metal particle layer is usually 5 nm to 200 nm and preferably 10 nm to 150 nm.

The average particle diameter of the metal particles is 5 nm to 200 nm, preferably 10 nm to 200 nm, and more preferably 10 nm to 150 nm. In a case where the average particle diameter of the metal particles is 5 nm to 200 nm, the metal particles can reflect visible light while transmitting millimeter waves. Therefore, the metal particles have radio wave transmission properties. In the present disclosure, the average particle diameter of the metal particles refers to the number average particle diameter calculated from the major diameter (maximum diameter) of the particles measured using an FE-SEM (50,000× magnification) observation image of the surface of the film. In a case where the metal particles are spherical, the average particle diameter refers to the number average particle diameter calculated from the diameter of the metal particles.

As described above, in the first step of the method according to an aspect of the present disclosure, the layer having functional groups ion-exchangeable with metal ions may be formed by modifying a surface of the resin substrate (first embodiment). Alternatively, the layer having functional groups ion-exchangeable with metal ions may be formed as a film on a surface of the resin substrate (second embodiment). Hereinafter, the first embodiment and the second embodiment of the method according to an aspect of the present disclosure will be described.

### First Embodiment

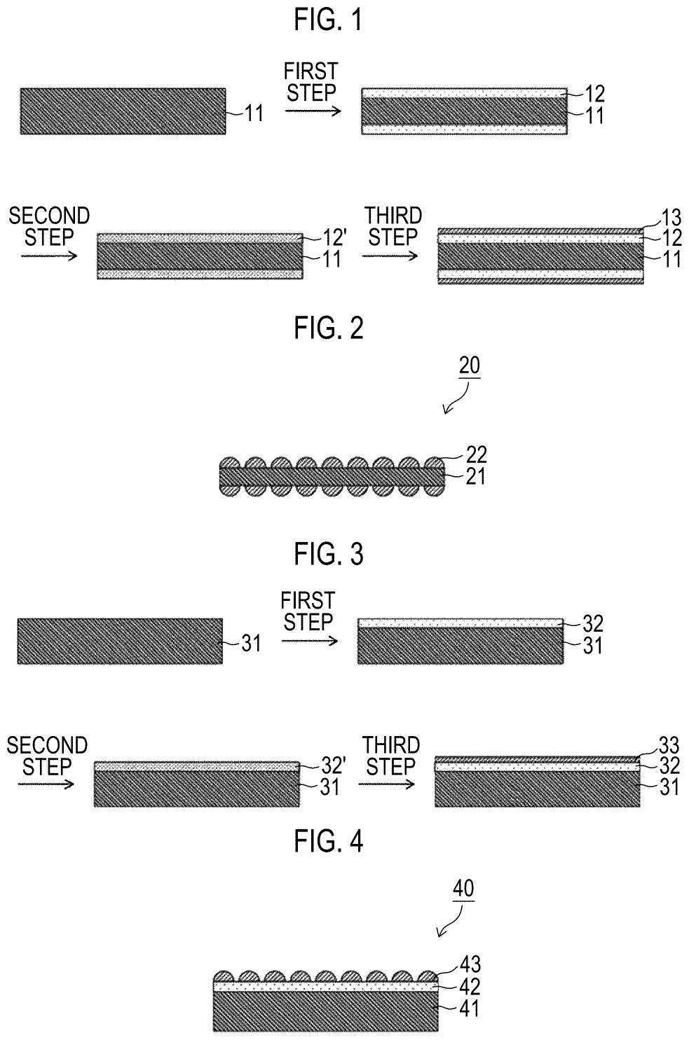

FIG. 1 is a view showing the process of the first embodiment of the method according to an aspect of the present disclosure. As shown in FIG. 1, the method of the first embodiment includes a first step of modifying a surface of a resin substrate 11 such that a modified layer 12 having functional groups ion-exchangeable with metal ions is formed on the surface of the resin substrate 11, a second step of treating the resin substrate 11 having the modified layer 12 formed on the surface with a metal ion solution such that metal ions are introduced into the modified layer 12 by ion exchange and that a modified layer 12′ into which the metal ions are introduced is formed on the resin substrate 11, and a third step of treating the resin substrate 11 having the modified layer 12′, into which the metal ions are introduced, on the surface with a reducing agent such that metal particles are precipitated on the surface and form a metal particle layer 13. Although not being shown in the drawing, voids are between the metal particles in the metal particle layer 13.

In the first step, a surface of the resin substrate is modified such that a modified layer having functional groups ion-exchangeable with metal ions is formed on the surface of the resin substrate.

The resin substrate is not limited as long as the surface thereof can be modified. It may be a resin substrate which has hydrolyzable functional groups and allows functional groups ion-exchangeable with metal ions to be introduced into the substrate by hydrolysis. As the resin substrate, for example, it is possible to use a resin having a group convertible into at least one of a carboxyl group or a sulfo group by hydrolysis. Examples of such a resin substrate include polycarbonate, acryl, and polyimide. The resin substrate is preferably polyimide having a high density of functional groups. In a case where polyimide is used as the resin substrate, by hydrolysis, a polyamic acid layer is formed on a surface of the substrate, and carboxyl groups are formed as functional groups ion-exchangeable with metal ions. As the resin substrate, it is also possible to use a resin into which a sulfo group can be introduced by surface modification. Examples of such a resin include polystyrene. For instance, by sulfonating the surface of the resin with concentrated sulfuric acid, it is possible to introduce a sulfo group into the resin.

The metal ions are not particularly limited, and, for example, are ions of Ag, Al, Au, Ti, Cr, Mn, Fe, Ni, Cu, Zn, Zr, Nb, Mo, In, Co, and Sn. Among these, ions of Ag, Al, and Cr are preferable, and Ag ions are more preferable, because these ions have high brightness.

In the first embodiment, the resin substrate is preferably polyimide, and the metal ions are preferably Ag ions.

In the first step, for example, by treating the surface of the resin substrate with an alkaline solution and causing hydrolysis, it is possible to form a modified layer having functional groups ion-exchangeable with metal ions.

The alkaline solution is not particularly limited, and examples thereof include NaOH, KOH, LiOH, CaO, and Ca(OH)₂. Among these, KOH is preferable.

The concentration of the alkaline solution is usually 1 M to 100 M and preferably 1 M to 10 M.

Regarding the condition of the treatment with an alkaline solution, the treatment temperature is usually 15° C. to 60° C. and preferably 25° C. to 50° C., and the treatment time is usually 30 seconds to 10 minutes and preferably 1 minute to 5 minutes.

In the first step, the density of the functional groups ion-exchangeable with metal ions in the formed modified layer is preferably 1 mol/l to 10 mol/l, and more preferably 5 mol/1 to 8 mol/l.

In the first step, the thickness of the modified layer is preferably 0.5 μm to 10 μm, and more preferably 0.7 μm to 1.5 μm.

In the second step, the resin substrate having the modified layer formed on the surface of the resin substrate is treated with a metal ion solution. As a result of this treatment, the functional groups are substituted with metal ions by ion exchange, and the metal ions are introduced into the modified layer.

The metal ion solution used in the second step and the concentration of the solution are as described above.

The treatment with the metal ion solution can be performed, for example, by immersing the resin substrate in the metal ion solution. Regarding the condition of the treatment with the metal ion solution, the treatment temperature is preferably 10° C. to 50° C. and more preferably 20° C. to 30° C., and the treatment time is preferably 10 seconds to 30 minutes and more preferably 1 minute to 10 minutes.

In the third step, the resin substrate having the modified layer, into which the metal ions are introduced, on the surface of the resin substrate is treated with a reducing agent. By this treatment, metal particles are precipitated on the surface, and a metallic film in which a metal particle layer is formed is obtained. The metal ions diffuse to the surface where the reducing agent is present and are reduced to metal particles. Therefore, the obtained metallic film has a resin substrate, a modified layer formed on the resin substrate, and a metal particle layer formed on the modified layer. In the present disclosure, each of the precipitated metal particles is partially embedded in the modified layer (surface of the resin substrate). Therefore, the metal particles are not easily peeled off.

The reducing agent used in the third step is as described above.

The treatment with the reducing agent can be performed, for example, by immersing the resin substrate in a reducing agent solution. The concentration of the reducing agent solution is preferably 0.01 mM to 500 mM, and more preferably 0.1 mM to 300 mM. In one embodiment, the concentration of the reducing agent solution is preferably 10 mM to 500 mM, and more preferably 100 mM to 300 mM. Regarding the condition of the treatment with the reducing agent, the treatment temperature is preferably 10° C. to 50° C. and more preferably 20° C. to 30° C., and the treatment time is preferably 10 seconds to 30 minutes and more preferably 30 seconds to 5 minutes.

In a preferred embodiment, the concentration of the reducing agent solution is 0.01 mM to 1 mM and preferably 0.1 mM to 0.5 mM. In a case where the reducing agent solution has a low concentration ranging from 0.01 mM to 1 mM, as described above, the metal particles are precipitated in a state of being more deeply embedded in the surface of the resin substrate. Therefore, the adhesion of the metal particles is enhanced, and the durability and wear resistance of the metal particles are improved. In this embodiment, regarding the condition of the treatment with the reducing agent, the treatment temperature is preferably 10° C. to 60° C., more preferably 20° C. to 50° C., and particularly preferably 50° C., and the treatment time is preferably 10 seconds to 30 minutes and more preferably 30 seconds to 5 minutes. In a case where the above reducing condition is adopted, it is possible to improve the adhesion, durability, and wear resistance of the metal particles while reducing the amount of the reducing agent used.

The method of the first embodiment may further include, after the third step, a fourth step of performing a heat treatment on the resin substrate such that the modified layer is converted. In one embodiment, in a case where the modified layer contains at least one of a carboxyl group or a sulfo group, these groups are dehydrated by the heat treatment. In this embodiment, the heat treatment temperature is usually 100° C. to 300° C.

The metallic film obtained by the method of the first embodiment includes a resin substrate, a modified layer formed on the resin substrate, and a metal particle layer formed on the modified layer. In a case where the fourth step is performed, the modified layer is converted into a resin substrate. Therefore, the obtained metallic film includes a resin substrate and a metal particle layer formed on the resin substrate.

FIG. 2 is a schematic sectional view of the metallic film obtained by the method of the first embodiment. The metallic film shown in FIG. 2 is obtained by performing the first to fourth steps in the first embodiment. As shown in FIG. 2, a metallic film 20 has a resin substrate 21 and metal particle layers 22 formed on both surfaces of the resin substrate 21. In the metal particle layer 22, there are voids between the metal particles. Because the metal particles have a specific average particle diameter, and there are voids between the metal particles, the metallic film has radio wave transmission properties. Furthermore, because the surface of the metallic film is smooth, the metallic film has high brightness. Each of the metal particles is partially embedded in the surface of the resin substrate. Therefore, the metal particles are not easily peeled off and have high stability, and the metallic film has high corrosion resistance and high weather fastness. The metallic film of the first embodiment may have a modified layer. Furthermore, the metallic film of the first embodiment may have a metal particle layer only on one surface of the resin substrate.

In a preferred aspect of the method of the first embodiment, the resin substrate is polyimide, and the metal ions are Ag ions. In this aspect, the method according to an embodiment of the present disclosure includes a first step of modifying a surface of a polyimide resin substrate with an alkaline solution (for example, KOH) such that polyimide is hydrolyzed and a carboxyl group-containing polyamic acid layer is formed on the surface of the resin substrate, a second step of treating the polyimide resin substrate having the polyamic acid layer formed on the surface of the resin substrate with an Ag ion solution (for example, a silver nitrate solution) such that Ag ions substitute H in the carboxyl groups by ion exchange and are introduced into the polyamic acid layer, and a third step of treating the polyimide resin substrate having the polyamic acid layer, into which the Ag ions are introduced, on the surface of the resin substrate with a reducing agent (for example, dimethylamine borane) such that Ag particles are precipitated on the surface of the polyamic acid layer. In this aspect, after the third step, a fourth step of converting the polyamic acid layer into polyimide by a heat treatment may be performed.

### Second Embodiment

FIG. 3 is a view showing the process of a second embodiment of the method according to an aspect of the present disclosure. As shown in FIG. 3, the method of the second embodiment includes a first step of forming a film layer 32 having functional groups ion-exchangeable with metal ions on a surface of a resin substrate 31, a second step of treating the resin substrate 31 having the film layer 32 formed on the surface of the resin substrate 31 with a metal ion solution such that metal ions are introduced into the film layer 32 by ion exchange and that a film layer 32′ into which the metal ions are introduced is formed, and a third step of treating the resin substrate 31 having the film layer 32′, into which the metal ions are introduced, formed on the surface of the resin substrate 31 with a reducing agent such that metal particles are precipitated on the of the film layer 32′ and form a metal particle layer 33. Although not being shown in the drawing, voids are between the metal particles in the metal particle layer 33.

As the resin substrate, resin films can be used without particular limitation. As the resin film, a transparent film is preferable. Examples of the film include polyethylene terephthalate, polycarbonate, polymethylmethacrylate, and acryl. Among these, polycarbonate and acryl are preferable. In the second embodiment, a film layer having functional groups ion-exchangeable with metal ions is formed on the resin substrate. Therefore, unlike in the first embodiment, the resin substrate may not have groups convertible into functional groups ion-exchangeable with metal ions.

The film layer to be formed on the resin substrate is not limited as long as the film layer has functional groups ion-exchangeable with metal ions. For example, it is possible to use a resin having at least one of a carboxyl group or a sulfo group. As the film layer, a polyamic acid and a styrene-divinylbenzene copolymer are preferable, and a polyamic acid is more preferable.

The film layer can be formed, for example, by coating a resin substrate with a resin solution for forming the film layer, drying the solution, and removing the solvent.

The thickness of the film layer is usually 0.5 μm to 10 μm, and preferably 0.7 μm to 1.5 μm.

In the film layer, the density of the functional groups ion-exchangeable with metal ions is preferably 1 mol/1 to 10 mol/l, and more preferably 5 mol/1 to 8 mol/l.

The metal ions are not particularly limited, and, for example, are ions of Ag, Al, Au, Ti, Cr, Mn, Fe, Ni, Cu, Zn, Zr, Nb, Mo, In, Co, and Sn. Among these, ions of Ag, Al, and Cr are preferable, and Ag ions are more preferable, because these ions have high brightness.

In the second embodiment, the resin substrate is preferably polycarbonate or acryl, the film layer is preferably a polyamic acid, and the metal ions are Ag ions.

In the second step, the resin substrate having the film layer formed on the surface of the resin substrate is treated with a metal ion solution. By this treatment, the functional groups ion-exchangeable with metal ions are substituted with metal ions by ion exchange, and the metal ions are introduced into the film layer.

The metal ion solution used in the second step and the concentration of the solution are as described above.

The treatment with the metal ion solution can be performed, for example, by immersing the resin substrate having the film layer formed on the surface of the resin substrate in the metal ion solution. Regarding the condition of the treatment with the metal ion solution, the treatment temperature is preferably 10° C. to 50° C. and more preferably 20° C. to 30° C., and the treatment time is preferably 1 minute to 60 minutes and more preferably be 15 minutes to 45 minutes.

In the third step, the resin substrate having the film layer, into which the metal ions are introduced, formed on the surface of the resin substrate is treated with a reducing agent. By this treatment, metal particles are precipitated on the surface, and a metallic film in which a metal particle layer is formed is obtained. The metal ions diffuse to the surface where the reducing agent is present and are reduced to metal particles. Therefore, the obtained metallic film has a resin substrate, a film layer formed on the resin substrate, and a metal particle layer formed on the film layer. In the present disclosure, each of the precipitated metal particles is partially embedded in the film layer. Therefore, the metal particles are not easily peeled off.

The reducing agent used in the third step is as described above.

The treatment with the reducing agent can be performed, for example, by immersing the resin substrate in a reducing agent solution. The concentration of the reducing agent is preferably 0.01 mM to 100 mM, and more preferably 0.1 mM to 50 mM. In one embodiment, the concentration of the reducing agent solution is preferably 1 mM to 100 mM, and more preferably 10 mM to 50 mM. Regarding the condition of the treatment with the reducing agent, the treatment temperature is preferably 25° C. to 60° C. and more preferably 40° C. to 60° C., and the treatment time is preferably 1 minute to 60 minutes and more preferably 5 minutes to 30 minutes.

In a preferred embodiment, the concentration of the reducing agent solution is 0.01 mM to 1 mM and preferably 0.1 mM to 0.5 mM. In a case where the reducing agent solution has a low concentration ranging from 0.01 mM to 1 mM, as described above, the metal particles are precipitated in a state of being more deeply embedded in the surface of the resin substrate. Therefore, the adhesion of the metal particles is enhanced, and the durability and wear resistance of the metal particles are improved. In this embodiment, regarding the condition of the treatment with the reducing agent, the treatment temperature may is preferably 25° C. to 60° C., more preferably 40° C. to 60° C., and particularly preferably 50° C., and the treatment time is preferably 1 minute to 60 minutes and more preferably 1 minute to 10 minutes. In a case where the above reducing condition is adopted, it is possible to improve the adhesion, durability, and wear resistance of the metal particles while reducing the amount of the reducing agent used.

The method of the second embodiment may further include, after the third step, a fourth step of performing a heat treatment on the resin substrate such that the film layer is converted. In one embodiment, in a case where the film layer contains at least one of a carboxyl group or a sulfo group, these groups are dehydrated by the heat treatment. In this embodiment, the heat treatment temperature is usually 100° C. to 300° C.

The metallic film obtained by the method of the second embodiment includes a resin substrate, a film layer formed on the resin substrate, and a metal particle layer formed on the film layer.

FIG. 4 is a schematic sectional view of the metallic film obtained by the method of the second embodiment. As shown in FIG. 4, a metallic film 40 has a resin substrate 41, a film layer 42 formed on the resin substrate 41, and a metal particle layer 43 formed on the film layer 42. The film layer and the metal particle layer may be formed on both surfaces of the resin substrate. In the metal particle layer 43, there are voids between the metal particles. Because the metal particles have a specific average particle diameter, and there are voids between the metal particles, the metallic film has radio wave transmission properties. Furthermore, because the surface of the metallic film is smooth, the metallic film has high brightness. Each of the metal particles is partially embedded in the surface of the film layer. Therefore, the metal particles are not easily peeled off and have high stability, and the metallic film has high corrosion resistance and high weather fastness.

In a preferred aspect of the method of the second embodiment, the resin substrate is polycarbonate or acryl, the film layer is a polyamic acid, and the metal ions are Ag ions. In this aspect, the method according to an embodiment of the present disclosure includes a first step of forming a polyamic acid layer on a surface of a polycarbonate or acrylic resin substrate, a second step of treating the resin substrate having the polyamic acid layer formed on the surface of the resin substrate with Ag ion solution (for example, a silver nitrate solution) such that Ag ions substitute H in carboxyl groups by ion exchange and are introduced into a film layer, and a third step of treating the resin substrate having the film layer, into which the Ag ions are introduced, formed on the surface of the resin substrate with a reducing agent (for example, dimethylamine borane) such that Ag particles are precipitated on the surface of the polyamic acid layer. In this aspect, after the third step, a fourth step of converting the polyamic acid layer into polyimide by a heat treatment may be performed.

The present disclosure also includes a metallic film obtained by the manufacturing method described above. The metallic film according to an aspect of the present disclosure has a resin substrate and a metal particle layer formed on the resin substrate. This metallic film can be obtained by performing the first to fourth steps described above for the first embodiment and the second embodiment.

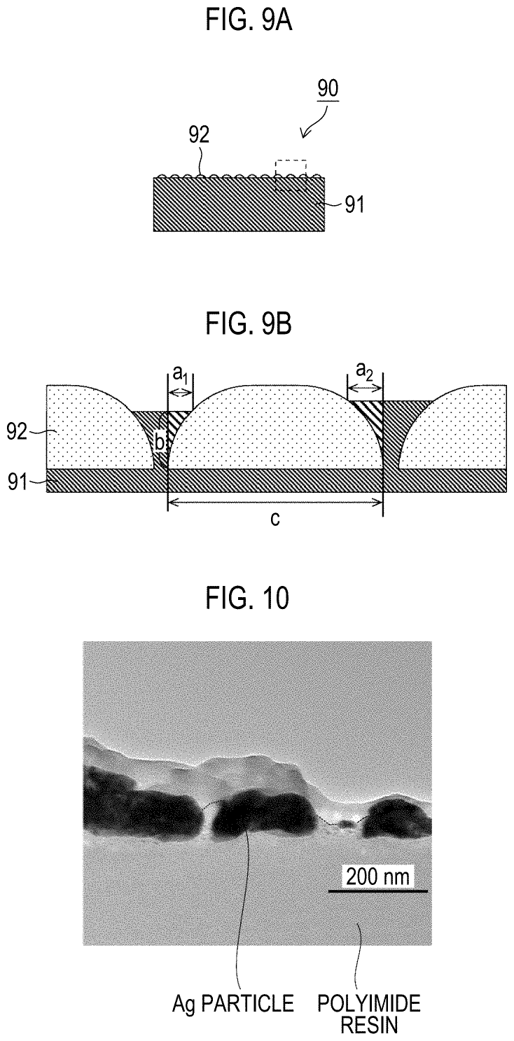

FIG. 9A is a schematic sectional view of the metallic film according to an aspect of the present disclosure. FIG. 9B is a partially enlarged sectional view of the portion shown in the dotted line in FIG. 9A. As shown in FIGS. 9A and 9B, a metallic film 90 has a resin substrate 91 and a metal particle layer 92 formed on a surface of the resin substrate 91. The metal particle layer 92 may be formed on both surfaces of the resin substrate 91.

In the metallic film according to an embodiment of the present disclosure, preferred aspects of the resin substrate and the metal particles are as described above for the metallic film manufacturing method.

In the metallic film according to an aspect of the present disclosure, the average particle diameter of the metal particles is 5 nm to 200 nm, preferably 10 nm to 200 nm, and more preferably 10 nm to 150 nm. In a case where the average particle diameter of the metal particles is 5 nm to 200 nm, the metal particles can reflect visible light while transmitting millimeter waves. Therefore, the metal particles have radio wave transmission properties. In the present disclosure, the average particle diameter of the metal particles refers to the number average particle diameter calculated from the major diameter (maximum diameter) of the particles measured using an FE-SEM (50,000× magnification) observation image of the surface of the film. In a case where the metal particles are spherical, the average particle diameter refers to the number average particle diameter calculated from the diameter of the metal particles.

In the metallic film according to an aspect of the present disclosure, there are voids between the metal particles. Because the metal particles have a specific average particle diameter, and there are voids between the metal particles, the metallic film according to an aspect of the present disclosure has radio wave transmission properties.

The surface of each of the metal particles is partially or totally embedded in the resin substrate. That is, as shown in FIG. 9B, in a section of the metallic film, in a case where c represents a horizontal major diameter (maximum diameter, nm) of each of the metal particles, a₁ represents a horizontal distance (nm) between a first endpoint of the horizontal major diameter of each of the metal particles and a first portion of each of the metal particles embedded in the resin substrate, and a₂ represents a horizontal distance (nm) between a second endpoint of the horizontal major diameter and a second portion of each of the metal particles embedded in the resin substrate, c, a₁, and a₂ satisfy 0<a₁/c, 0<a₂/c, and a₁+a₂≤c. The first portion is the nearest portion of the metal particle embedded in the resin substrate from the first endpoint. The second portion is the nearest portion of the metal particle embedded in the resin substrate from the second endpoint. In the metallic film according to an aspect of the present disclosure, because the average particle diameter of the metal particles is 5 nm to 200 nm, the horizontal major diameter c (nm) of each of the metal particles satisfies 5≤c≤200. In a preferred embodiment, c, a₁, and a₂ satisfy 0<a₁/c≤0.5, 0<a₂/c≤0.5, and a₁+a₂≤c. The surface of each of the metal particles is partially or totally embedded in the resin substrate. Therefore, the metal particles are not easily peeled off, have high adhesiveness and high durability or wear resistance. A vertical length b (nm) of the portion of each of the metal particles that is embedded in the resin substrate is usually 1 nm to 50 nm.

The metallic film according to an aspect of the present disclosure can achieve both the high brightness and radio wave transmission properties. Therefore, the metallic film can be used for products that need to have radio wave transmission properties.

Hereinafter, the present disclosure will be more specifically described using examples. However, the technical scope of the present disclosure is not limited to these examples.

### Example 1

As a resin substrate, a polyimide film having a thickness of 50 μm (manufactured by DU PONT-TORAY CO., LTD., KAPTON 200H) was used. The size of the polyimide film was 5 cm×5 cm.

The polyimide film was immersed in a 5 M KOH solution at 50° C. for 1 minute such that the surface of the polyimide film was hydrolyzed and a polyamic acid layer was formed.

Silver nitrate (AgNO₃) (31018-14, manufactured by NACALAI TESQUE, INC.) was dissolved in pure water, thereby preparing a 100 mM AgNO₃ solution. After being rinsed with water, the film was immersed in the prepared AgNO₃ solution at room temperature for 5 minutes such that Ag ions were introduced into the polyamic acid layer by ion exchange.

Dimethylamine borane (DMAB) (028-08401 manufactured by FUJIFILM Wako Pure Chemical Corporation) was dissolved in pure water, thereby preparing a 200 mM DMAB solution. After being rinsed with water, the film was immersed in the DMAB solution at room temperature for 1 minute such that the Ag ions were reduced and Ag particles were precipitated on the surface of the polyimide film. The film was rinsed with water and subjected to a heat treatment at 200° C. such that the polyamic acid was converted into polyimide. In this way, a metallic film was obtained.

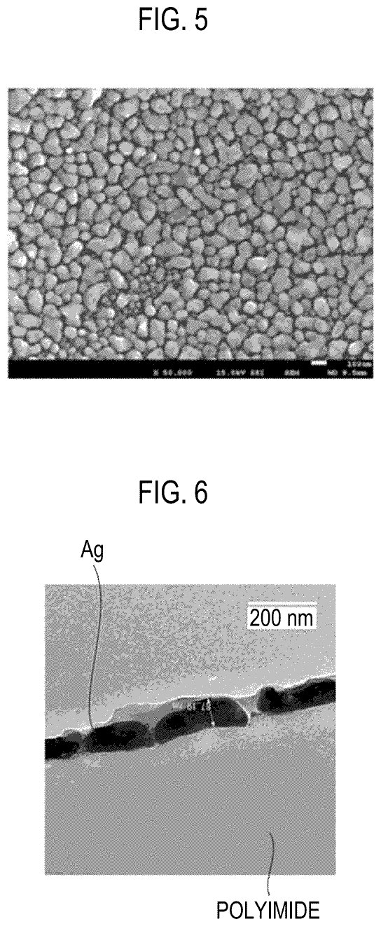

FIG. 5 is a scanning electron microscope (SEM) image of the surface of the metallic film of Example 1. FIG. 6 is a transmission electron microscope (TEM) image of a section of the metallic film of Example 1. As shown in FIGS. 5 and 6, Ag particles were precipitated in the form of islands on the surface of the polyimide film, and there were voids between the Ag particles. Furthermore, as shown in FIG. 6, the Ag particles were partially embedded in the polyimide film. The number average particle diameter calculated from the major diameter of the Ag particles measured using the FE-SEM (50,000× magnification) observation image of the film surface was 100 nm.

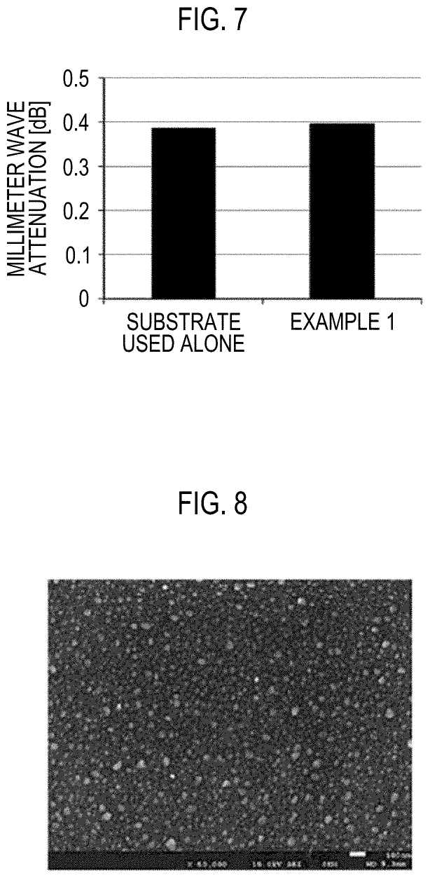

By measuring the millimeter wave attenuation in the metallic film of Example 1 and in a substrate used alone, the millimeter wave transmission properties were evaluated. By using a millimeter wave characteristic analyzer having horn antennas, the millimeter wave attenuation in one direction was measured. The measured value was multiplied by 2, thereby determining the millimeter wave attenuation. Specifically, by causing a transmitting horn antenna to emit millimeter waves to a measurement sample, and measuring the intensity of the millimeter waves that came into a receiving horn antenna after passing through the sample, the attenuation in one direction was determined. The distance between the transmitting horn antenna and the receiving horn antenna was 95 cm. The sample was installed such that an angle of elevation between the sample and the transmitting horn antenna was 17° and that the distance between the sample and the transmitting horn antenna was about 40 mm. FIG. 7 shows the millimeter wave attenuation in Example 1 and in a substrate used alone. In FIG. 7, the lower the millimeter wave attenuation, the higher the millimeter wave transmission properties. As shown in FIG. 7, the millimeter wave attenuation in the metallic film of Example 1 was equivalent to the millimeter wave attenuation in the substrate used alone, which showed that the metallic film of Example 1 has excellent millimeter wave transmission properties.

### Example 2

As a resin substrate, an acryl film having a thickness of 50 μm (TECHNOLLOY (registered trademark) S001G acryl film manufactured by Sumika Acryl Co., Ltd) was used. The size of the acryl film was 2 cm×5 cm.

A surface of the acryl film was spin-coated with 250 μL of a polyamic acid solution (Pyre-M. L. (registered trademark) manufactured by I.S.T Corporation) at 1,000 rpm for 15 seconds and then at 3,000 rpm for 60 seconds, and dried in vacuum at 40° C. for 1 hour, thereby forming a polyamic acid layer on the surface of the acryl film.

AgNO₃ (31018-14 manufactured by NACALAI TESQUE, INC.) was dissolved in pure water, thereby preparing a 100 mM AgNO₃ solution. The surface of the film was rinsed with water, and then the film was immersed in the AgNO₃ solution at room temperature for 30 minutes such that Ag ions were introduced into the polyamic acid layer by ion exchange.

DMAB (028-08401 manufactured by FUJIFILM Wako Pure Chemical Corporation) was dissolved in pure water, thereby preparing a 20 mM DMAB solution. The film was immersed in the DMAB solution at 50° C. for 15 minutes such that Ag ions were reduced and Ag particles were precipitated on the surface of the polyamic acid layer. Then, the film was rinsed with water and dried, thereby obtaining a metallic film.

FIG. 8 is an SEM image of the surface of the metallic film of Example 2. As shown in FIG. 8, Ag particles were precipitated in the form of islands on the surface of the film, and there were voids between the Ag particles. The number average particle diameter calculated from the major diameter of the Ag particles measured using the FE-SEM observation image of the film surface was 10 nm.

For the metallic film of Example 2, millimeter wave attenuation was measured as round-trip attenuation in the same manner as in Example 1. As a result, millimeter wave attenuation was 0.02 dB, which showed that the metallic film of Example 2 has significantly high millimeter wave transmission properties.

### Examples 3 and 4 and Comparative Example 1

### Example 3

As a resin substrate, a polyimide film having a thickness of 50 μm (manufactured by DU PONT-TORAY CO., LTD., KAPTON 200H) was used. The size of the polyimide film was 5 cm×5 cm.

The polyimide film was immersed in a 5 M KOH solution at 50° C. for 5 minutes such that the surface of the polyimide film was hydrolyzed and a polyamic acid layer was formed.

Silver nitrate (AgNO₃) (31018-14, manufactured by NACALAI TESQUE, INC.) was dissolved in pure water, thereby preparing a 100 mM AgNO₃ solution. After being rinsed with water, the film was immersed in the prepared AgNO₃ solution at room temperature for 5 minutes such that Ag ions were introduced into the polyamic acid layer by ion exchange.

Dimethylamine borane (DMAB) (028-08401 manufactured by FUJIFILM Wako Pure Chemical Corporation) was dissolved in pure water, thereby preparing a 0.2 mM DMAB solution. After being rinsed with water, the film was immersed in the DMAB solution at 50° C. for 2 minutes such that the Ag ions were reduced and Ag particles were precipitated on the surface of the polyimide film. The film was rinsed with water and subjected to a heat treatment at 200° C. such that the polyamic acid was converted into polyimide. In this way, a metallic film was obtained.

### Example 4

A metallic film of Example 4 was obtained in the same manner as in Example 3, except that the concentration of the DMAB solution of the reducing agent was changed to 0.1 mM.

### Comparative Example 1

As Comparative Example 1, a film was used which was obtained by forming an indium film on a surface of a substrate by the conventional vapor deposition method.

FIG. 10 shows a TEM image of a section of the metallic film of Example 3. The upper part of the Ag particles is covered with deposits generated during the processing for observation. As shown in FIG. 10, there were voids between the Ag particles. Furthermore, as illustrated in the portion shown in the dotted line, a part of the surface of each of the Ag particles was embedded in the polyimide film. Here, a part of the surface of each of the Ag particles was more deeply embedded in the polyimide film of the metallic film of Example 3 than in the polyimide film of the metallic film of Example 1. Furthermore, in the metallic film of Example 4, the entire surface of each of the Ag particles was embedded in the polyimide film.

TEM images of sections of the metallic films of Examples 3 and 4 and Comparative Example 1 were obtained. In these TEM images, as shown in FIG. 9B, a horizontal major diameter c (nm) of each of the metal particles, a horizontal distance a₁ (nm) between one endpoint of the horizontal major diameter of each of the metal particles and a portion of each of the metal particles embedded in the resin substrate on the horizontal major diameter, and a horizontal distance a₂ (nm) between the other endpoint of the horizontal major diameter and a portion of each of the metal particles embedded in the resin substrate on the horizontal major diameter were measured. Each of the measured a₁, a₂ and, c is the average for 10 particles. In the metallic film of Example 4, the entire surface of the Ag particles was embedded in the polyimide film. In these Ag particles, a₁ represents the distance between the midpoint of the major diameter c and the left endpoint of c, and a₂ represents the distance between the midpoint of the major diameter c and the right endpoint of c.

Tape Peel-Off Test

For the metallic films of Examples 3 and 4 and Comparative Example 1, a tape peel-off test was performed by the cross-cut adhesion test. Specifically, on a surface of each film, cuts were made at intervals of 1 mm in the vertical and horizontal directions such that 100 grids were created. Then, an adhesive tape was stuck to the surface and peeled off Thereafter, by counting the number of grids peeled off, the film was evaluated. The results are shown in Table 1.

Pencil Scratch Test

A pencil scratch test was performed using a pencil with pencil hardness F. Specifically, the pencil was held such that it contacted the film at an angle of 45°, and while being pressed on the film surface under a load of 1,000 g, the pencil was pushed at a rate of 10 mm/s until the film was scratched by 20 mm. The test was performed 5 times. The results are shown in Table 1.

TABLE 1

| | | | | Tape peel-off test | Pencil scratch |
|---|---|---|---|---|---|
| | | | | Number of grids | test Number of |
| | a₁/c | a₂/c | c | peeled off | scratches |
| Example 3 | 0.05 | 0.04 | 190 nm | 0/100 | 0/5 |
| Example 4 | 0.5 | 0.5 | 20 nm | 0/100 | 0/5 |
| Comparative | 0.0 | 0.0 | 140 nm | 100/100 | 5/5 |
| Example 1 | | | | | |

As shown in Table 1, in Examples 3 and 4 in which the reducing agent solution has low concentration, the surface of the metal particles was partially or totally embedded in the resin substrate. The results of the tape peel-off test show that the metal particles exhibit high adhesiveness in the tensile direction. Furthermore, the results of the pencil scratch test show that the metal particles exhibit high adhesiveness and high wear resistance in the shear direction. Therefore, from the viewpoint of improving the adhesiveness, durability, and wear resistance of the metal particles, it is preferable that the reducing agent solution used for manufacturing a metallic film have low concentration ranging, for example, from 0.01 mM to 1 mM.

What is claimed is:

1. A metallic film manufacturing method, comprising:
a first step of forming a layer which has functional groups ion-exchangeable with metal ions on a surface of a resin substrate made of an insulating material;
a second step of treating the resin substrate having the layer which has the functional groups ion-exchangeable with the metal ions and is formed on the surface of the resin substrate with a metal ion solution such that metal ions are introduced into the layer by ion exchange; and
a third step of treating the resin substrate having the layer into which the metal ions are introduced on the surface of the resin substrate with a reducing agent such that metal particles are precipitated on a surface of the layer, wherein:
there are voids between the metal particles precipitated on the surface of the layer; and
an average particle diameter of the metal particles is 5 nm to 200 nm.

2. The metallic film manufacturing method according to claim 1, wherein the metal ions are ions of one or more metals selected from Ag, Al, Au, Ti, Cr, Mn, Fe, Ni, Cu, Zn, Zr, Nb, Mo, In, Co, and Sn.

3. The metallic film manufacturing method according to claim 1, further comprising a fourth step of performing a heat treatment after the third step.

4. The metallic film manufacturing method according to claim 1, wherein in the first step, the surface of the resin substrate is modified such that the layer having the functional groups ion-exchangeable with the metal ions is formed on the surface of the resin substrate.

5. The metallic film manufacturing method according to claim 4, wherein the resin substrate is a resin having a group that is convertible into at least one of a carboxyl group or a sulfo group.

6. The metallic film manufacturing method according to claim 5, wherein the resin substrate is polyimide.

7. The metallic film manufacturing method according to claim 1, wherein in the first step, a film layer having the functional groups ion-exchangeable with the metal ions is formed on the surface of the resin substrate.

8. The metallic film manufacturing method according to claim 1, wherein:
the resin substrate having the layer into which the metal ions are introduced on the surface of the resin substrate is treated with a reducing agent solution in which a concertation of the reducing agent is 0.01 mM to 1 mM such that the metal particles are precipitated on the surface of the layer.

9. A metallic film comprising:
a resin substrate; and
a metal particle layer formed on the resin substrate, wherein:
in the metal particle layer, there are voids between metal particles;
an average particle diameter of the metal particles is 5 nm to 200 nm; and
in a section of the metallic film, in a case where c represents a horizontal major diameter of each of the metal particles, a₁ represents a horizontal distance between a first endpoint of the horizontal major diameter of each of the metal particles and a first portion of each of the metal particles embedded in the resin substrate, and a₂ represents a horizontal distance between a second endpoint of the horizontal major diameter and a second portion of each of the metal particles embedded in the resin substrate, c, a₁, and a₂ satisfy 0<a₁/c, 0<a₂/c, and a₁+a₂≤c.
